(19) United States
(12) Patent Application Publication
(10) Pub. No.: US 2004/0075910 A1
(43) Pub. Date: Apr. 22, 2004

(54) Optical antireflection film and process for forming the same

(75) Inventors: Atsushi Shozude, Hyogo (JP); Isao Tokomoto, Hyogo (JP); Takanobu Hori, Hyogo (JP); Takeshi Furutsuka, Hyogo (JP)

Correspondence Address: MARSHALL, GERSTEIN & BORUN LLP, 6300 SEARS TOWER, 233 S. WACKER DRIVE, CHICAGO, IL, 60606, US

(73) Assignee: SHINMAYWA INDUSTRIES, LTD., Hyogo (JP)

(21) Appl. No.: 10/644,555

(22) Filed: Aug. 20, 2003

(30) Foreign Application Priority Data
Mar. 18, 2003 (JP) 2003-73315
Sep. 9, 2002 (JP) 2002-262508

(51) Int. Cl. G02B 5/08; G02B 17/00

(52) U.S. Cl. 359/603

(57) ABSTRACT

A first SiO film having a refractive index substantially equal to the refractive index of an acrylic resin substrate is formed to a thickness of about 200 nm on the substrate, and a second SiO film having a refractive index assuming a value falling within the range from 1.48 to 1.62 is formed to a thickness of about 200 nm on the first SiO film. Further, in the case of an HLHL type antireflection film for example, a TiO₂ film having a refractive index assuming a value falling within the range from 2.2 to 2.4 is formed as the layer next to the outermost layer with a special ion plating apparatus.

### BACKGROUND OF THE INVENTION

1. Field of the Invention

The present invention relates to an antireflection film for use in optical systems and a process for forming the same.

2. Description of the Related Art

Optical systems including an optical lens or an objective lens for reading the contents of information recorded in a compact disk are formed with antireflection films for reducing losses in light quantity and like losses due to reflection. Heretofore, glass has been heavily used as the material for substrates on which such antireflection films are to be formed. Recently, however, there have been increasingly used synthetic resins, which are light and applicable to volume production by injection molding, particularly, acrylic resins (polymethyl methacrylate (PMMA) and the like) which are excellent in light transmittance also.

Typical antireflection film structures include one so-called “HLHL type” and one so-called “MHL type”. An antireflection film of the HLHL type comprises a multi-layered film stacked on a substrate in a manner that adjacent layers thereof have their refractive indexes that are different from each other while the refractive indexes of the respective layers alternately and relatively assume high/low values. Such a multi-layered film consists of four or five layers or more, of which the outermost layer (the layer situated most remotely from the substrate) comprises a film having a relatively low refractive index. An antireflection film of the MHL type comprises three layers stacked on a substrate, including the layer situated most closely to the substrate, which comprises a film having a relatively medium refractive index, the intermediate layer which comprises a film having a relatively high refractive index, and the layer situated most remotely from the substrate, which comprises a film having a relatively low refractive index.

Various antireflection film structures formed on synthetic resin substrates have been disclosed (see patent document 1: Japanese Patent Publication No. 3221764 (Tables 1 to 6), and patent document 2: Japanese Patent Laid-Open Publication No. 2002-202401 (Tables 1 and 5) for example). Generally, synthetic resins have flexibility and are liable to be attacked by chemicals. For this reason, in forming an antireflection film on a synthetic resin substrate a silicon oxide film is formed over the substrate and then a multi-layered film of the aforementioned HLHL type or MHL type is formed on the silicon oxide film to form the antireflection film.

If such a silicon oxide film is too thin (for example, 200 nm or less), it is difficult for the silicon oxide film to ensure satisfactory characteristics in adhesion to the substrate, environmental resistance (resistance to heat and moisture, and like resistances), wear resistance, chemical resistance, and like properties. FIG. 11 is a photograph showing an example of a surface condition of an antireflection film having a relatively thin silicon oxide film after having undergone an environment test. The antireflection film was formed by forming the relatively thin silicon oxide film over the surface of a synthetic resin substrate and then forming a multi-layered film of the HLHL type having an antireflection characteristic on the silicon oxide film. As can be seen from FIG. 11, a multiplicity of cracks occurred on the surface of the antireflection film when the silicon oxide film was relatively thin, which means that an antireflection film having a relatively thin silicon oxide film is poor in environmental resistance. For this reason such a silicon oxide film is usually formed to be relatively thick, or as thick as 300 nm or more, on a single layer basis. The antireflection films disclosed in the aforementioned patent documents 1 and 2 have such a relatively thick silicon oxide film each.

In many cases films forming respective layers constituting such an antireflection film are formed by a process including heating and evaporating a film forming material with an electron beam emitted from an electron gun disposed in a vacuum chamber to allow the evaporated material to deposit on a substrate. This is because this process is superior in controllability and operability in film formation and hence is easy to ensure stabilized film forming conditions.

From the view point of the antireflection characteristic in terms of an optical characteristic, it is preferred that a silicon oxide film as described above have a refractive index assuming a value falling within the range of 1.48 to 1.62, preferably 1.5 to 1.6, and a thickness of about 200 nm. However, it has hitherto been impossible to reduce the thickness of such a silicon oxide film to about 200 nm for the reason stated above.

Generally, an antireflection film that is formed on a substrate comprising an acrylic resin, in particular, with use of an electron gun, exhibits very low adhesion. This is because a part of electrons emitted from such an electron gun to irradiate a film forming material rebounds off the material and then impinges upon the surface of the substrate as secondary electrons, resulting in the substrate surface altered. Though the prior art employs a method of capturing secondary electrons with a magnet placed in a vacuum chamber, the size of such a vacuum chamber applicable to this method is limited and, what is more, the capturing effect varies depending on different places within the chamber, causing non-uniform adhesive force working between the antireflection film and the substrate.

In contrast, an antireflection film formed by employing a wet process, such as coating or dipping, to form a hard coat on an acrylic resin substrate, exhibits improved adhesion and wear resistance. However, such an antireflection film has a problem of an increased film thickness as well as a problem that a hard coat liquid having a refractive index substantially equal to that of the acrylic resin substrate does not exist and, hence, the antireflection characteristic is degraded due to optical interference between the acrylic resin substrate and the hard coat. There exists a method of forming an antireflection film by forming all the films constituting the antireflection film by evaporation utilizing resistance heating. The antireflection film formed by this method is satisfactory in adhesion. However, this method involves problems that the stability of quality in volume production and the operability in the manufacture are low and that high-melting-point materials cannot be used as film forming materials.

In the case of an antireflection film of the aforementioned HLHL type, the film forming the layer next to the outermost layer preferably has a refractive index as high as possible. If the substrate comprises glass, the refractive index of the film of interest to be formed can be raised by heating the substrate to about 300° C. However, since acrylic resins for substrates are heat-resistant up to about 80° C., it has heretofore been impossible to attain a sufficiently high refractive index. In the case of the antireflection films disclosed in the foregoing patent publications, the film forming the layer next to the outermost layer has a refractive index of no more than about 2.15. For this reason, realization of a higher refractive has been desired.

Among practical materials for optical films, magnesium fluoride (MgF₂) has the lowest refractive index (refractive index n=1.38) and, hence, the use of magnesium fluoride for the outermost layer of an antireflection film will improve the antireflection characteristic of the antireflection film. Since such a magnesium fluoride film can be imparted with sufficient hardness if it is formed with the substrate heated, magnesium fluoride is widely used in antireflection films employing glass as their substrates. However, if a film of magnesium fluoride is formed on an acrylic resin substrate without heating, the film thus formed is very brittle and is poor in wear resistance. For this reason it has heretofore been impossible to use magnesium fluoride in an antireflection film employing an acrylic resin substrate.

If the so-called plasma-ion process, which has conventionally been used, is employed to form a MgF₂ film without heating the substrate, the MgF₂ film thus obtained can exhibit sufficient hardness. This process, however, raises the problem that the resulting MgF₂ film is deficient in fluorine. As a result, the film becomes brownish and hence has such a high absorptivity as to make it absolutely impossible to use the film as an optical film.

### SUMMARY OF THE INVENTION

The present invention has been made to solve the above-described problems. A first object of the present invention is to provide an optical antireflection film which is satisfactory in adhesion to an underlying substrate formed from a synthetic resin, environmental resistance, wear resistance and chemical resistance and which has advantageous optical characteristics, as well as to provide a process for forming the same. A second object of the present invention is to provide an optical antireflection film which employs a substrate formed from a synthetic resin and which comprises a so-called HLHL type multi-layered film in which a film forming the layer next to the outermost layer has a refractive index much higher than in the prior art, as well as to provide a process for forming the same. A third object of the present invention is to provide an optical antireflection film which employs a substrate formed from a synthetic resin and which comprises a so-called MHL type multi-layered film including a MgF₂ film having sufficient hardness and a sufficiently low refractive index suited for an optical film, as well as to provide a process for forming the same.

With a view to attaining the aforementioned objects, the present invention provides an optical antireflection film formed on a substrate formed from a synthetic resin, comprising: a first film formed on a surface of the substrate, the first film having a predetermined thickness and a refractive index substantially equal to a refractive index of the substrate; a second film formed on a surface of the first film, the second film having a predetermined thickness and a refractive index assuming a value falling within a range from 1.48 to 1.62 and comprising a material same as or different from a material forming the first film; and a multi-layered film formed on a surface of the second film, the multi-layered film having an antireflection characteristic. Preferably, the first and second films, in particular, comprise a silicon oxide.

With this construction, it is possible that the first film having a thickness of about 100 to about 200 nm for example is first formed in order that the total thickness of the first and second films can ensure sufficient adhesion, environmental resistance, wear resistance, chemical resistance and the like and then the second film having a refractive index assuming a value falling within the range from 1.48 to 1.62, preferably 1.5 to 1.6 is formed to a preferable thickness (about 200 nm for example) so as to impart the antireflection film with favorable optical characteristics. Since the refractive index of the first film is substantially equal to that of the synthetic resin substrate, the provision of the first film can hardly deteriorate the optical characteristics of the antireflection film. If the first and second films are formed from the same material, the adhesion between the first and second films can be enhanced further. Particularly where the first and second films are formed from the silicon oxide, the antireflection film can ensure sufficient adhesion, environmental resistance, wear resistance, chemical resistance and the like while keeping its optical characteristics satisfactory.

The aforementioned substrate may be formed from an acrylic resin. As described above, by virtue of the provision of the first and second films, the antireflection film can ensure sufficiently high adhesion to the substrate even if the substrate is formed from an acrylic resin having poor adhesion, whereby the antireflection film can be inhibited to crack.

The aforementioned first film may be a product obtained by a vacuum deposition method utilizing resistance heating. This feature makes it possible to form the first film comprising a silicon oxide as a major component without any damage (for example, alteration) to the surface of the substrate. Further, since the surface of the substrate is coated with the first film, the surface of the substrate can be protected from damage due to secondary electrons. Thus, it is possible to use an electron gun in forming any film on or above the first film.

The aforementioned multi-layered film may comprise films stacked in a manner that adjacent ones of the films have respective refractive indexes that are different from each other and that alternately and relatively assume high/low values. With this feature the antireflection film, if provided with the so-called HLHL type multi-layered film, can enjoy the above-described advantages.

Preferably, the aforementioned multi-layered film has a third film as a layer next to an outermost layer which is situated most remotely from the second film, the third film having a refractive index assuming a value falling within a range from 2.2 to 2.4. This feature makes it possible to obtain a HLHL type antireflection film with the third film having such a high refractive index as never attained by any prior art antireflection film and, hence, an antireflection film having superior optical characteristics can be realized.

The aforementioned third film may comprise one selected from the group consisting of TiO₂, Ti₂O₃, Ti₃O₅, Ta₂O₅, ZrO₂, Nb₂O₅, and a mixture of TiO₂ and ZrO₂, as a major component thereof. With this feature the antireflection film can have the advantages described above.

The aforementioned third film may be obtained by a process in which a film forming apparatus comprising a vacuum chamber and a bias supply electrode disposed within the vacuum chamber is employed and which comprises the steps of: placing the substrate on the bias supply electrode; evaporating a film forming material within the vacuum chamber; supplying a high-frequency voltage to the bias supply electrode serving as one electrode to generate plasma within the vacuum chamber; and applying the bias supply electrode with a bias voltage having a frequency of not less than 20 KHz and not more than 2.45 GHz and varying in a wave form. The bias voltage may have a negative mean value and a positive maximum value.

Alternatively, the aforementioned third film may be obtained by a process in which a film forming apparatus comprising a vacuum chamber and an ion beam generating structure for generating an ion beam for use in film formation is employed and which comprises the steps of: placing the substrate within the vacuum chamber; causing the ion beam generating structure to generate the ion beam; and depositing a film forming material on a surface of the substrate by utilizing the ion beam within the vacuum chamber. It is possible that the ion beam generating structure is an ion gun while the step of depositing the film forming material comprises the steps of: irradiating the film forming material with the ion beam generated by the ion gun to evaporate the film forming material; and depositing the film forming material thus evaporated on the surface of the substrate. It should be noted that the concept “evaporation utilizing an ion beam” includes evaporation by sputtering utilizing an ion beam.

Yet alternatively, the aforementioned third film may be obtained by a process in which a film forming apparatus comprising a vacuum chamber, a plasma generating structure for generating plasma to be supplied into vacuum chamber (for example a plasma gun), and a bias supply electrode disposed within the vacuum chamber is employed and which comprises the steps of: placing the substrate on the bias supply electrode; causing the plasma generating structure to generate plasma thereby to generate an electron beam comprising electrons present in the plasma and guiding the electron beam into the vacuum chamber; irradiating a film forming material with the electron beam to evaporate the film forming material; generating plasma within the vacuum chamber by the electron beam; and applying the bias supply electrode with a bias voltage to cause the film forming material evaporated to deposit on a surface of the substrate.

This feature makes it possible to form the third film having a high refractive index without heating the substrate, the refractive index being substantially as high as that of a film formed with the substrate heated. Thus, it is possible to realize an antireflection film having superior optical characteristics even if the substrate is formed from a low heat-resistant material such as an acrylic resin.

The aforementioned multi-layered film may comprise stacked three layers consisting of an outer layer film situated most remotely from the second film, an inner layer film situated most closely to the second film, and an intermediate layer film situated intermediate between the outer layer film and the inner layer film, the outer layer film having a refractive index that is lowest of refractive indexes of the respective films forming the three layers, the intermediate layer film having a refractive index that is highest of the refractive indexes of the respective films forming the three layers, the inner layer film having a refractive index that assumes a medium value between the refractive index of the outer layer film and that of the intermediate layer film.

With this feature the antireflection film, if provided with the so-called MHL type multi-layered film, can enjoy the above-described advantages.

Preferably, the aforementioned outer layer film comprises magnesium fluoride (MgF₂) as a major component thereof. This feature makes it possible to realize an antireflection film having more excellent optical characteristics by virtue of the use of MgF₂, which is particularly low in refractive index among practical optical materials.

The aforementioned outer layer film may be obtained by a process in which a film forming apparatus comprising a vacuum chamber and a bias supply electrode disposed within the vacuum chamber is employed and which comprises the steps of: placing the substrate on the bias supply electrode; evaporating a film forming material within the vacuum chamber; supplying a high-frequency voltage to the bias supply electrode serving as one electrode to generate plasma within the vacuum chamber; and applying the bias supply electrode with a bias voltage having a negative mean value and a positive maximum value and a frequency of not less than 20 KHz and not more than 2.45 GHz and varying in a wave form.

Alternatively, the aforementioned outer layer film may be obtained by a process in which a film forming apparatus comprising a vacuum chamber, a plasma generating structure for generating plasma to be supplied into the vacuum chamber (for example a plasma gun), and a bias supply electrode disposed within the vacuum chamber is employed and which comprises the steps of: placing the substrate on the bias supply electrode; causing the plasma generating structure to generate plasma thereby to generate an electron beam comprising electrons present in the plasma and guiding the electron beam into the vacuum chamber; irradiating a film forming material with the electron beam to evaporate the film forming material; generating plasma within the vacuum chamber by the electron beam; and applying the bias supply electrode with a bias voltage having a negative mean value and a positive maximum value.

This feature makes it possible to form the outermost layer without heating the substrate. When a MgF₂ film is formed as the outermost layer, the resulting MgF₂ film can be imparted with sufficiently high hardness and a low refractive index and rendered free of fluorine deficiency and hence can provide for an antireflection film having superior optical characteristics.

According to the present invention, there is also provided a process for forming an optical antireflection film on a substrate formed from a synthetic resin, comprising the steps of: forming a first film to a predetermined thickness on a surface of the substrate by a vacuum deposition method utilizing resistance heating, the first film having a refractive index substantially equal to a refractive index of the substrate; forming a second film to a predetermined thickness on a surface of the first film by a vacuum deposition method utilizing resistance heating, the second film having a refractive index assuming a value falling within a range from 1.48 to 1.62 and comprising a material same as or different from a material forming the first film; and forming a multi-layered film having an antireflection characteristic on a surface of the second film. Preferably, the first and second films, in particular, each comprise a silicon oxide as a major component thereof.

With this construction, it is possible that the first film having a thickness of about 100 to about 200 nm for example is first formed in order that the total thickness of the first and second films can ensure sufficient adhesion, environmental resistance, wear resistance, chemical resistance and the like and then the second film having a refractive index assuming a value falling within the range from 1.48 to 1.62, preferably 1.5 to 1.6 is formed to a preferable thickness (about 200 nm for example) so as to impart the antireflection film with favorable optical characteristics. Since the refractive index of the first film is substantially equal to that of the substrate formed from the synthetic resin, the provision of the first film can hardly deteriorate the optical characteristics of the antireflection film.

It is possible that: the step of forming the aforementioned multi-layered film comprises the step of stacking films on the surface of the second film in a manner that adjacent ones of the films have respective refractive indexes that are different from each other and that alternately and relatively assuming high/low values, the step of stacking the films comprising the step of forming a third film as a layer next to an outermost layer which is situated most remotely from the substrate, the third film comprising one film forming material selected from the group consisting of TiO₂, Ti₂O₃, Ti₃O₅, Ta₂O₅, ZrO₂, Nb₂O₅, and a mixture of TiO₂ and ZrO₂, as a major component thereof.

By thus forming the multi-layered film it is also possible to realize a so-called HLHL type optical antireflection film which is excellent in adhesion, environmental resistance, wear resistance and chemical resistance as well as in optical antireflection characteristic even if the substrate is formed from an acrylic resin for example.

It is possible that in the step of forming the aforementioned third film, a film forming apparatus comprising a vacuum chamber and a bias supply electrode disposed within the vacuum chamber is employed, and the step of forming the aforementioned third film comprises the steps of: placing the substrate on the bias supply electrode; evaporating one film forming material selected from the aforementioned group within the vacuum chamber; supplying a high-frequency voltage to the bias supply electrode serving as one electrode to generate plasma within the vacuum chamber; and applying the bias supply electrode with a bias voltage having a frequency of not less than 20 KHz and not more than 2.45 GHz and varying in a wave form. The bias voltage may have a negative mean value and a positive maximum value.

Alternatively, it is possible that in the step of forming the aforementioned third film, a film forming apparatus comprising a vacuum chamber and an ion gun for generating an ion beam to irradiate a film forming material placed within the vacuum chamber with the ion beam is employed, and the step of forming the aforementioned third film comprises the steps of: placing the substrate within the vacuum chamber; causing the ion gun to generate the ion beam and irradiating one film forming material selected from the aforementioned group with the ion beam thus generated to evaporate the film forming material; and depositing the film forming material thus evaporated on a surface of the substrate.

Yet alternatively, it is possible that in the step of forming the aforementioned third film, a film forming apparatus comprising a vacuum chamber, a plasma gun for generating plasma to be supplied into the vacuum chamber and a bias supply electrode disposed within the vacuum chamber is employed, and the step of forming the aforementioned third film comprises the steps of: placing the substrate on the bias supply electrode; causing the plasma gun to generate plasma thereby to generate an electron beam comprising electrons present in the plasma and guiding the electron beam into the vacuum chamber; irradiating one film forming material selected from the aforementioned group with the electron beam thus generated to evaporate the film forming material; generating plasma within the vacuum chamber by the electron beam; and applying the bias supply electrode with a bias voltage to cause the film forming material evaporated to deposit on a surface of the substrate.

This feature makes it possible to form the third film having a high refractive index without heating the substrate, the refractive index of the third film being substantially as high as that of a film formed with the substrate heated. Thus, it is possible to realize an antireflection film having superior optical characteristics even if the substrate is formed from a low heat-resistant material such as an acrylic resin.

Preferably, the step of forming the aforementioned multi-layered film comprises the steps of: forming an inner layer film situated most closely to the second film; forming an intermediate layer film on the inner layer film; and forming an outer layer film situated most remotely from the second film, the outer layer film having a refractive index that is lowest of refractive indexes of the respective films forming the three layers, the intermediate layer film having a refractive index that is highest of the refractive indexes of the respective films forming the three layers, the inner layer film having a refractive index assuming a medium value between the refractive index of the outer layer film and that of the intermediate layer film, the step of forming the outer layer film is the step of forming a film comprising magnesium fluoride as a major component thereof.

By thus forming the multi-layered film it is also possible to realize a so-called MHL type antireflection film having the above-described superior characteristics.

It is possible that in the step of forming the aforementioned outer layer film comprising magnesium fluoride (MgF₂) as a major component thereof, a film forming apparatus comprising a vacuum chamber and a bias supply electrode disposed within the vacuum chamber is employed, and the step of forming the aforementioned outer layer film comprising magnesium fluoride comprises the steps of: placing the substrate on the bias supply electrode; evaporating magnesium fluoride as a film forming material within the vacuum chamber; supplying a high-frequency voltage to the bias supply electrode serving as one electrode to generate plasma within the vacuum chamber; and applying the bias supply electrode with a bias voltage having a negative mean value and a positive maximum value and a frequency of not less than 20 KHz and not more than 2.45 GHz and varying in a wave form.

Alternatively, it is possible that in the step of forming the aforementioned outer layer film comprising magnesium fluoride as a major component thereof, a film forming apparatus comprising a vacuum chamber, a plasma gun for generating plasma to be supplied into the vacuum chamber, and a bias supply electrode disposed within the vacuum chamber is employed, and the step of forming the aforementioned outer layer film comprising magnesium fluoride comprises the steps of: placing the substrate on the bias supply electrode; causing the plasma gun to generate plasma thereby to generate an electron beam comprising electrons present in the plasma and guiding the electron beam into the vacuum chamber; irradiating magnesium fluoride as a film forming material with the electron beam to evaporate the magnesium fluoride within the chamber; generating plasma within the vacuum chamber by the electron beam; and applying the bias supply electrode with a bias voltage having a negative mean value and a positive maximum value to cause the film forming material evaporated to deposit on a surface of the substrate.

This feature makes it possible to form the outermost layer without heating the substrate. When a MgF₂ film is formed as the outermost layer, the resulting MgF₂ film can be imparted with sufficiently high hardness and a low refractive index and rendered free of fluorine deficiency and hence can provide for an antireflection film having superior optical characteristics.

These and other objects, features and attendant advantages of the present invention will become more apparent from the reading of the following detailed description of the invention in conjunction with the accompanying drawings.

### BRIEF DESCRIPTION OF THE DRAWINGS

FIG. 1 is a sectional view illustrating the construction of an antireflection film according to an embodiment of the present invention;

FIG. 2 is a table listing the respective major components and respective physical thicknesses and optical thicknesses of layers constituting each antireflection film according to the embodiment and the design wavelengths for the respective layers;

FIG. 3 is a sectional view illustrating the construction of another antireflection film according to the embodiment of the present invention;

FIG. 4 is a sectional view illustrating the construction of an antireflection film as a comparative example for comparison with the antireflection films according to the embodiment;

FIG. 5 is a schematic illustration of an example of film forming apparatus capable of forming optical films such as the TiO₂ film forming the fifth layer of the antireflection film shown in FIG. 1 and the MgF₂ film forming the fifth layer of the antireflection film shown in FIG. 3;

FIG. 6 is a diagram showing an example of a bias voltage waveform outputted from a bias power source unit included in the film forming apparatus shown in FIG. 5;

FIG. 7 is a graph plotting the potential of a substrate holder included in the film forming apparatus shown in FIG. 5;

FIG. 8 is a graph plotting the reflectance of each of the antireflection films shown in FIGS. 1, 3 and 4 varying with different wavelengths of light;

FIG. 9 is a photograph representing the result of a wear resistance test conducted on the antireflection films shown in FIGS. 1 and 3;

FIG. 10 is a photograph representing the result of a wear resistance test conducted on the antireflection film shown in FIG. 4;

FIG. 11 is a photograph of a surface condition of an antireflection film having a relatively thin silicon oxide film on a substrate after having undergone an environmental test;

FIG. 12 is a schematic illustration of another example of film forming apparatus capable of forming optical films such as the TiO₂ film forming the fifth layer of the antireflection film shown in FIG. 1;

FIG. 13 is a schematic illustration of yet another example of film forming apparatus capable of forming optical films such as the TiO₂ film forming the fifth layer of the antireflection film shown in FIG. 1; and

FIG. 14 is a schematic illustration of still another example of film forming apparatus capable of forming optical films such as the TiO₂ film forming the fifth layer of the antireflection film shown in FIG. 1.

### DETAILED DESCRIPTION OF THE PREFERRED EMBODIMENTS

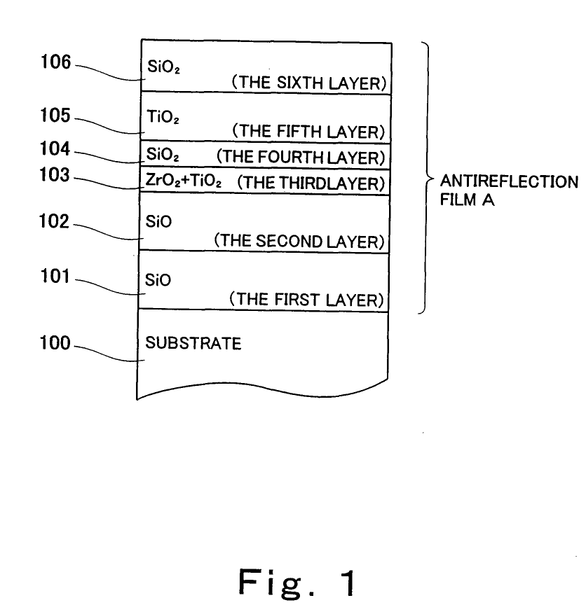

Hereinafter, embodiments of the present invention will be described in detail with reference to the drawings. FIG. 1 is a sectional view illustrating the construction of an antireflection film according to an embodiment of the present invention. The antireflection film A shown in FIG. 1 is an antireflection film having a so-called HLHL type multi-layered film. The antireflection film A is constructed of a multi-layered film having a six-layer structure comprising first to sixth layer films formed on a substrate 100 formed from an acrylic resin (PMMA) sequentially in an ascending order from the substrate 100.

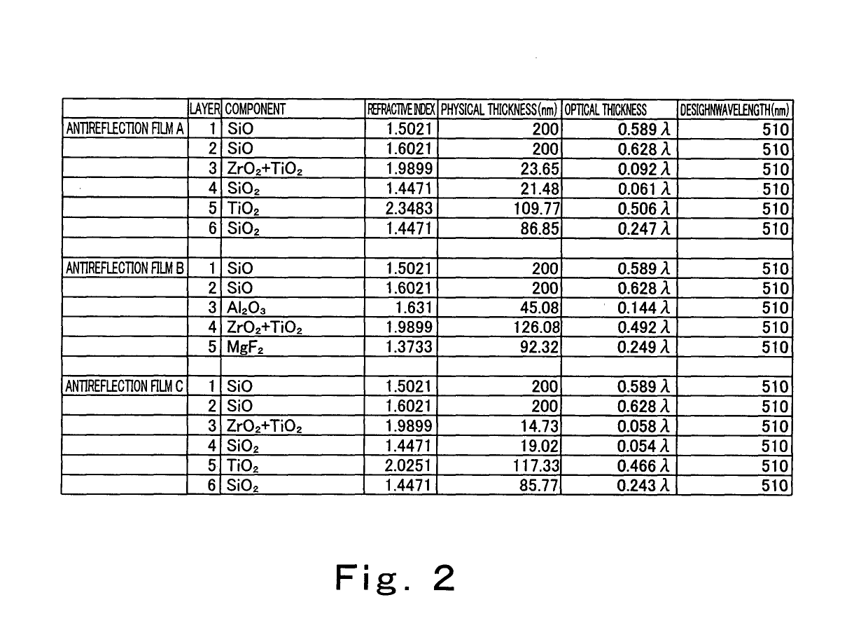

FIG. 2 is a table listing the major components and the physical thicknesses (nm) and optical thicknesses of the respective layers constituting each of antireflection films according to the embodiment and the design wavelengths (nm) for the respective layers. As shown in FIGS. 1 and 2, the antireflection film A includes a SiO film 101 as the first layer, a SiO film 102 as the second layer, a film comprising a mixture of ZrO₂ and TiO₂ (ZrO₂+TiO₂ film) 103 as the third layer, a SiO₂ film 104 as the fourth layer, a TiO₂ film 105 as the fifth layer, and a SiO₂ film 106 as the sixth layer.

Here, the SiO film 101 forming the first layer desirably has a refractive index substantially equal to the refractive index of the material of the substrate 100. In this embodiment the SiO film 101 is formed to have a refractive index of 1.502, which is substantially equal to that of the acrylic resin used. Further, the SiO film 101 is formed to have a predetermined thickness such that the total thickness of the first layer SiO film 101 and the second layer SiO film 102 ensures sufficient adhesion, environmental resistance, wear resistance and chemical resistance. In this embodiment the thickness of the SiO film 101 is 200 nm. The SiO film 101 is formed on the substrate 100 within a vacuum chamber by a vacuum deposition method utilizing resistance heating.

The refractive index of a SiO film varies depending on the ratio between the content of silicon atom and the content of oxygen atom in the film. Accordingly, it is possible to form a SiO film having a desired refractive index by providing an appropriate oxygen atmosphere in the vacuum chamber during vacuum deposition. When the substrate 100 is formed from an acrylic resin, the refractive index of the first layer SiO film 101 desirably assumes a value falling within the range from about 1.48 to about 1.51.

The second layer SiO film 102 desirably has a refractive index assuming a value falling within the range from 1.48 to 1.62 so as to ensure superior optical characteristics. In this embodiment the SiO film 102 is formed to have a refractive index of 1.6021. The thickness of the SiO film 102 is 200 nm and, hence, the combination of the first layer SiO film 101 and the second layer SiO film 102 forms a SiO film having a total thickness of 400 nm on the substrate 100. For this reason the antireflection film A is excellent in adhesion to the substrate 100 formed from an acrylic resin, environmental resistance, wear resistance and chemical resistance. Like the first layer SiO film 101, the second layer SiO film 102 is formed in an appropriate oxygen atmosphere by a vacuum deposition method utilizing resistance heating.

As the third layer, the ZrO₂+TiO₂ film 103 comprising a mixed material of ZrO₂ and TiO₂ is formed having a relatively high refractive index (refractive index n=1.9899 in this embodiment). The ZrO₂+TiO₂ film 103 is formed on the aforementioned second film by vacuum deposition in which a mixed material comprising ZrO₂ and TiO₂ are heated with an electron gun. As described above, the first layer SiO film 101 and second layer SiO film 102 having a total thickness of 400 nm have already been formed on the substrate 100 before the formation of ZrO₂+TiO₂ film 103. Thus, even though vacuum deposition is performed using the electron gun, the surface of the substrate 100 is protected from impingement of secondary electrons thereupon and hence is prevented from alteration. Accordingly, there is no possibility of affecting the adhesion between the antireflection film A and the substrate 100.

As the fourth layer, the SiO₂ film 104 is formed having a relatively low refractive index (n=1.4471 in this embodiment) as compared to the refractive index of the third layer ZrO₂+TiO₂ film 103. The SiO₂ film 104 is formed on the third layer by vacuum deposition using an electron gun.

As the fifth layer, the TiO₂ film 105 is formed having a sufficiently high refractive index (n=2.3483 in this embodiment) relative to the refractive index of the fourth layer SiO₂ film 104. The TiO₂ film 105 is formed by a method employing a special ion plating apparatus. This method makes it possible to realize the fifth layer having such a high refractive index as never attained by the prior art. The special ion plating apparatus and the film forming method employing this apparatus will be described later.

As the sixth layer, the SiO₂ film 106 is formed having a sufficiently low refractive index (n=1.4471 in this embodiment) relative to the refractive index of the fifth layer TiO₂ film 105. The SiO₂ film 106 is formed on the fifth layer by vacuum deposition using an electron gun.

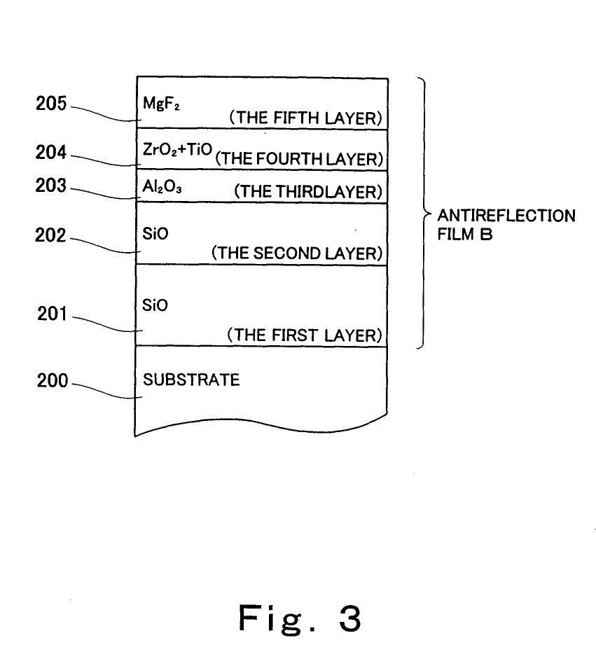

FIG. 3 is a sectional view illustrating the construction of another antireflection film according to the embodiment of the present invention. The antireflection film B shown in FIG. 3 is an antireflection film having a so-called MHL type multi-layered film. The antireflection film B is constructed of a multi-layered film having a five-layer structure comprising first to fifth layer films formed on a substrate 200 of an acrylic resin sequentially in an ascending order from the substrate 200.

As shown in FIGS. 2 and 3, the antireflection film B includes a SiO film 201 as the first layer, a SiO film 202 as the second layer, an Al₂O₃ film 203 as the third film, a film comprising a mixture of ZrO₂ and TiO₂ (ZrO₂+TiO₂ film) 204 as the fourth layer, and a MgF₂ film 205 as the fifth layer.

Here, the first layer SiO film 201 and the second layer SiO film 202 are each formed in the same manner as with the corresponding one of the first layer SiO film 101 and second layer SiO film 102 of the antireflection film A shown in FIG. 1 and hence are identical with the corresponding films 101 and 102 in features (refractive index, thickness and the like). Thus, the antireflection film B is excellent in adhesion to the substrate 200 formed from the acrylic resin, environmental resistance, wear resistance and chemical resistance as well as in optical characteristics.

As the third layer, the Al₂O₃ film 203 is formed having a refractive index assuming a medium value (n=1.631 in this embodiment) between the respective refractive indexes of the fourth layer ZrO₂+TiO₂ film 204 and fifth layer MgF₂ film 205 to be described below. The Al₂O₃ film 203 is formed on the second layer by vacuum deposition using an electron gun.

As the fourth layer, the ZrO₂+TiO₂ film 204 is formed having a relatively high refractive index (n=1.9899 in this embodiment) as compared to the refractive index of the third layer Al₂O₃ film 203. The ZrO₂+TiO₂ film 204 is formed on the third layer by vacuum deposition using an electron gun.

As the fifth layer, the MgF₂ film 205 is formed having a relatively low refractive index (n=1.3733 in this embodiment) as compared to the refractive index of the third layer Al₂O₃ film 203. The MgF₂ film 205 is formed by a method employing a special ion plating apparatus similar to the method employed to form the fifth layer TiO₂ film 105 of the antireflection film A. This method makes it possible to realize the MgF₂ film 205 having high wear resistance and superior optical characteristics without heating the substrate 200. In this case there is no need to form a film having superior wear resistance (for example SiO₂ film) as the outermost layer additionally.

As already described, since the antireflection film A,B has the first layer SiO film 101,201 and second layer SiO film 102,202 formed on substrate 100,200, it is possible to heat and evaporate the film forming material using an electron gun to form a film as the third layer or a higher-order layer. Thus, this method offers higher quality stability in volume production and higher operability in the manufacture and allows higher-melting-point film forming materials to be used.

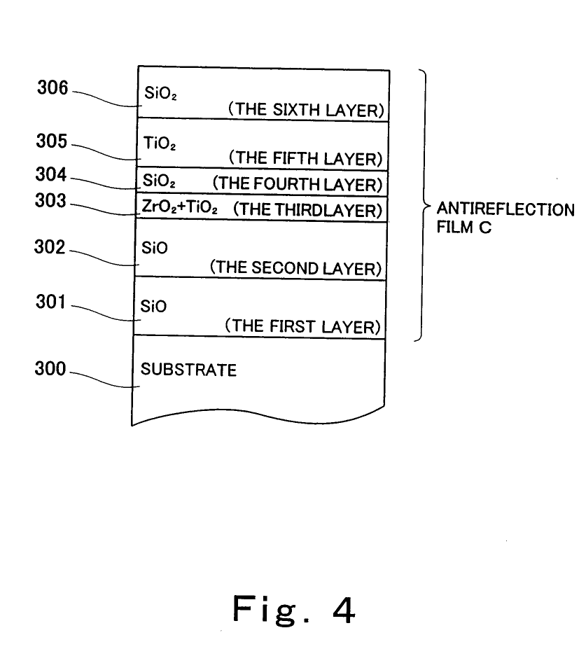

FIG. 4 is a sectional view showing the construction of an antireflection C formed without employing the aforementioned special ion plating apparatus for comparison with the antireflection films A and B according this embodiment. As shown in FIGS. 2 and 4, the antireflection film C is a so-called HLHL type antireflection film comprising a same substrate and same materials as used in the antireflection film A shown in FIG. 1. That is, the antireflection film C includes a SiO film 301 as the first layer, a SiO film 302 as the second layer, a film comprising a mixture of ZrO₂ and TiO₂ (ZrO₂+TiO₂ film) 303 as the third layer, a SiO₂ film 304 as the fourth layer, a TiO₂ film 305 as the fifth layer, and a SiO₂ film 306 as the sixth layer. What is different from the antireflection film A is that the fifth layer TiO₂ film 305 is formed by a known vacuum deposition method without using the aforementioned special ion plating apparatus.

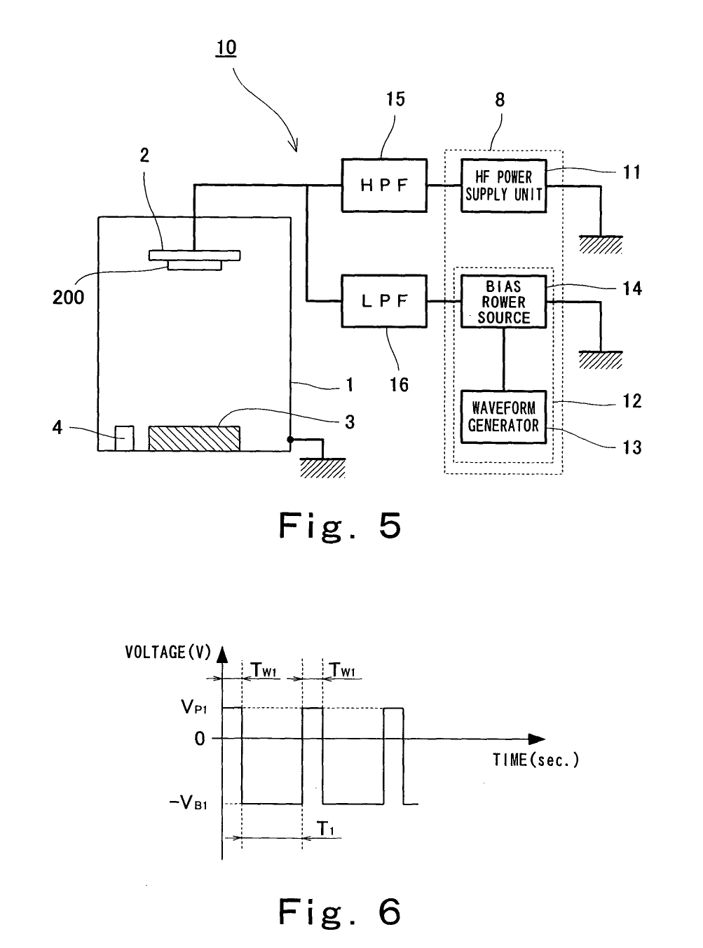

Description will be made of the aforementioned special ion plating apparatus and the film forming method employing the apparatus. FIG. 5 is a schematic illustration of an example of film forming apparatus capable of forming optical films such as the fifth layer TiO₂ film included in the antireflection film A shown in FIG. 1 and the fifth layer MgF₂ film included in the antireflection film B shown in FIG. 3. The film forming apparatus 10 shown is constructed to be capable of forming a film based on ion plating as a film forming method.

The film forming apparatus 10 includes a vacuum chamber 1 and an electric power supply unit 8 as major components thereof. The vacuum chamber 1, which is constructed of an electro-conductive material, is grounded. A substrate holder 2 for holding a substrate to be formed with films (substrate 200 for example) is disposed on an upper side within the vacuum chamber 1. The substrate holder 2 is constructed of an electro-conductive material. The substrate holder 2 is driven for rotation by means of a motor not shown and, hence, a film can be formed on the substrate 200 being rotated by the substrate holder 2. On a lower side within the vacuum chamber 1 are disposed a crucible 3 for holding a film forming material, and an electron gun 4 for irradiating the film forming material held in the crucible 3 with an electron beam.

The film forming apparatus 10 is provided with evacuation means, such as a vacuum pump, not particularly shown and gas supply means and hence is capable of providing the inside space of the vacuum chamber 1 with a desired vacuum atmosphere or with, for example, a desired oxygen atmosphere (or an argon atmosphere or the like).

The electric power supply unit 8 includes a high-frequency power source unit 11 and a bias power source unit 12. The high-frequency power source unit 11 has one output terminal connected to the substrate holder 2 via a high pass filter (HPF) 15 and the other output terminal grounded. The bias power source unit 12 has one output terminal connected to the substrate holder 2 via a low pass filter (LPF) 16 and the other output terminal grounded.

Thus, the substrate holder 2 also serves as an electrode for supplying both high-frequency power and bias power into the vacuum chamber 1. When high-frequency power is applied to the substrate holder 2, plasma is generated within the vacuum chamber 1 to ionize (excite) the film forming material evaporated from the crucible 3.

The value and frequency of electric power to be outputted by the high-frequency power source unit 11 are specifically and appropriately determined depending on the material of a film to be formed, the film forming conditions and like factors.

A matching box not particularly shown is provided intermediate the high-frequency power source unit 11 and the high pass filter 15. This matching box, which includes a well-known matching circuit comprising a capacitor, a coil and the like, is capable of matching the impedance on the high-frequency power source unit 11 side and the impedance on the vacuum chamber 1 side with each other by adjusting the matching circuit.

On the other hand, the bias power source unit 12 includes a waveform generator 13 and a bias power source 14. The waveform generator 13 generates a waveform for a bias voltage to be outputted from the bias power source unit 12 and inputs the waveform to the bias power source 14. The waveform generator 13 is capable of generating various waveforms, such as d.c. waveforms each steadily assuming a constant value, a.c. waveforms of different frequencies, square waves and triangular waves, as basic waveforms. The waveform generator 13 is also capable of composing another basic waveform based on plural basic waveforms. The bias power source 14 outputs a bias voltage amplified to a predetermined magnitude of power based on such a basic waveform generated by the waveform generator 13.

The high pass filter 15 has the function of permitting power outputted from the high-frequency power source unit 11 to pass therethrough toward the substrate holder 2 side while blocking the inputting of power outputted from the bias power source unit 12 to the high-frequency power source unit 11. The low pass filter 16 has the function of permitting power outputted from the bias power source unit 12 to pass therethrough toward the substrate holder 2 side while blocking the inputting of power outputted from the high-frequency power source unit 11 to the bias power source unit 12.

The following description is directed to the bias voltage outputted from the bias power source unit 12. FIG. 6 shows an example of a bias voltage waveform outputted from the bias power source unit 12. In FIG. 6 the abscissa represents time (sec.) while the ordinate represents the magnitude of voltage value (V).

As shown in FIG. 6, the value of bias voltage varies between the positive side and the negative side periodically. More specifically, the bias voltage is in the form of a square wave pulse and comprises a positive bias assuming a constant positive voltage value (Vₚ₁) for duration T_{W1} of one period (T_{W1}+T₁) and a negative bias assuming a constant negative voltage value (−V_{B1}) for the other duration T₁ of one period (T_{W1}+T₁).

With use of the film forming apparatus 10 described above, an optical film can be formed in the following manner. While the film forming procedure to be described below is to form the fifth layer MgF₂ film 205 of the aforementioned antireflection film B, the fifth layer TiO₂ film 105 of the antireflection film A can be formed following a similar procedure.

First, the crucible 3 is loaded with a film forming material comprising MgF₂, while the substrate 200 is set on the substrate holder 2. In setting the substrate 200 on the substrate holder 2 the substrate 200 is placed so that its obverse side to be formed with a film faces opposite to the crucible 3. The electron gun 4 is then caused to emit an electron beam to irradiate the film forming material with the electron beam thereby to evaporate the film forming material.

On the other hand, the power supply unit 8 is actuated to supply high-frequency power into the vacuum chamber 1 through the substrate holder 2, and the bias power source unit 12 is actuated to apply a bias voltage to the substrate holder 2.

By so doing, plasma is generated in the vacuum chamber 1. The film forming material evaporated from the crucible 3 is ionized (excited) during the passage thereof through plasma thus generated. Resulting ionized MgF₂ impinge and deposit on the substrate 200, thus forming a MgF₂ film on the substrate 200.

In the process of forming a film on the substrate 200 with the film forming apparatus 10, when high-frequency power is applied to the substrate holder 2 and plasma is generated within the vacuum chamber 1, a negative potential is provided adjacent the obverse side of the substrate 200 due to what is called “self-bias”.

Such a negative potential due to the self-bias and a negative bias caused by the bias voltage make it possible to accelerate the movement of positively-charged ionized MgF₂ toward the substrate 200. In this way the negative bias caused by the bias voltage enables further acceleration of the movement of such ionized MgF₂, thus making the film to be formed on the substrate 200 have a denser structure.

Though fluorine, which is loosely bound, is easily dissociated from ionized MgF₂ in the film forming process using the film forming apparatus 10, the positive bias produced by the bias voltage during duration T_{W1} allows negatively-charged fluorine ions to be incorporated into the film being formed on the substrate 200. Thus, the film to be formed on the substrate 200 can be prevented from becoming fluorine deficient and, hence, it is possible to avoid any degradation in the optical characteristics of the MgF₂ film which would otherwise occur due to the deficiency of fluorine.

Here, a brief description is made of the self-bias. The high pass filter 15 has a blocking capacitor (not shown) serially connected to the high-frequency power source unit 11. This blocking capacitor has the function of permitting the high-frequency component of a current to pass therethrough but blocking the d.c. component of the current. Accordingly, when high-frequency power is supplied into the vacuum chamber 1, electric charge which flows into the substrate holder 2 from plasma generated by the supply of high-frequency power is accumulated in the blocking capacitor. An offset voltage, which is determined by the capacity of the blocking capacitor and the amount of charge in the capacitor, is generated across the opposite ends of the blocking capacitor and is applied to the substrate holder 2. Since electrons present in plasma travel toward the substrate holder 2 at a higher speed than do ions present in plasma, the offset voltage assumes a constant negative value on the substrate holder 2 side. Such voltage generated at an electrode (the substrate holder 2 in this case) in contact with plasma according to this mechanism is referred to as “self-bias”.

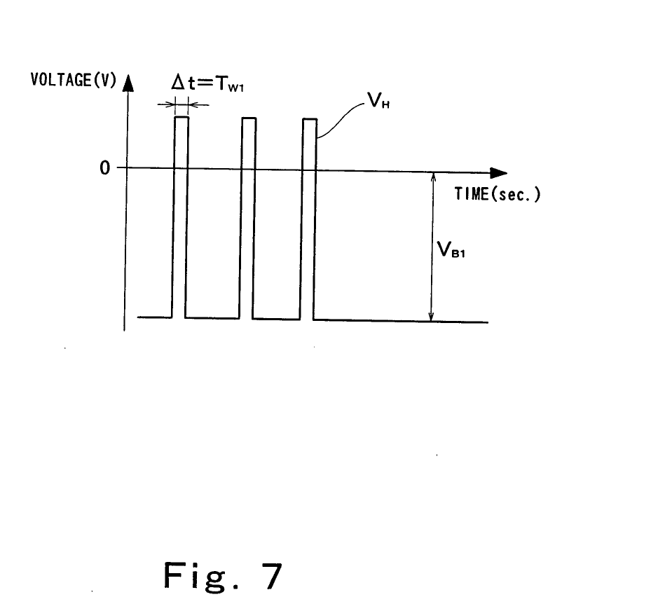

The relationship between the self-bias and the bias voltage outputted from the bias power source unit 12 is described below. The blocking capacitor included in the high pass filter 15 and the bias power source 12 are connected in parallel with each other with respect to the substrate holder 2. In such a case one of the self-bias and the bias voltage outputted from the bias power source unit 12, whichever the superior, is predominantly applied to the substrate holder 2. In this embodiment the bias voltage outputted from the bias power source unit 12 is superior to the self-bias and hence is predominantly applied to the substrate holder 2. FIG. 7 is a graph plotting the potential of the substrate holder 2. As shown in FIG. 7, potential VH Of the substrate holder 2 substantially conforms to the bias voltage (refer to FIG. 6) generated by the bias power source unit 12 and varies as does the bias voltage.

The bias voltage for use in the present invention is not limited to a bias voltage of the waveform shown in FIG. 6. For example, the bias voltage may have a sinusoidal waveform. Preferably, the bias voltage has a negative means value and a positive maximum value and a frequency of not less than 20 KHz and not more than 2.45 GHz and varies in a waveform. Though a bias voltage having a higher frequency is more desirable, a bias voltage having too high a frequency renders plasma generated within the vacuum chamber 1 unstable. For this reason, a bias voltage having a frequency of not more than 2.45 GHz is practically desirable.

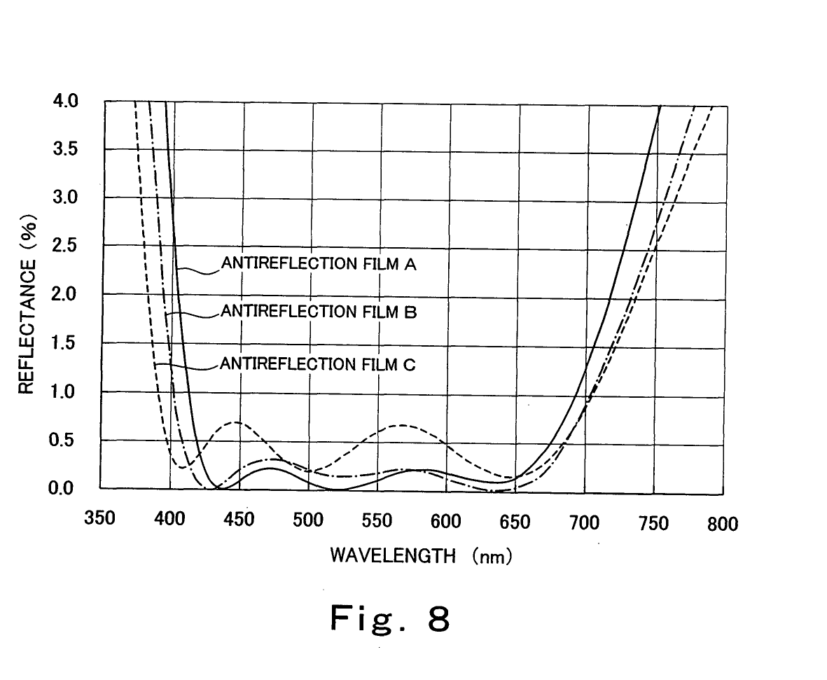

The following description is directed to comparison between the antireflection films A and B according to this embodiment and the antireflection film C as a comparative example. FIG. 8 is a graph plotting the reflectance of each of the antireflection films A, B and C with respect to different wavelengths (about 350 to about 800 nm) of light.

As shown in FIG. 8, each of the antireflection films A and B exhibited a mean reflectance of about 0.2% with respect to light having a wavelength ranging from about 400 to about 650 nm, while in contrast the antireflection film C exhibited a mean reflectance of about 0.5% with respect to light having a wavelength in the same range. As can be understood therefrom, the antireflection films A and B according to this embodiment both have better antireflection characteristics than the antireflection film C formed without employing the film forming apparatus 10.

It can be assumed that the transmittance of the aforementioned antireflection film A is 99.8% with respect to light having a wavelength in the abovementioned range, provided that the light passing through the film incurs no loss of light quantity. Likewise, it can be assumed that the transmittance of the antireflection film B and that of the antireflection film C are 99.8% and 99.5%, respectively.

Accordingly, when a lens, for example, is coated with antireflection film A on both sides thereof, the transmittance of the antireflection film A coating this lens (hereinafter referred to as “lens A”) is 99.6%. Similarly, when a lens is coated with antireflection film B on both sides thereof, the transmittance of the antireflection film B coating this lens (hereinafter referred to as “lens B”) is 99.6%. On the other hand, when a lens is coated with antireflection film C on both sides thereof, the transmittance of the antireflection film C coating this lens (hereinafter referred to as “lens C”) is 99.0%. Thus, there is a difference as large as about 0.6% in the transmittance of the antireflection film between the lens A or B and the lens C.

In general, many camera lens arrays for telephotography comprise a combination of not less than 10 lenses. When such a camera lens array is constructed using lens A, B or C., the transmittance of a camera lens array comprising lenses A or B is 0.996¹⁰=0.961 (96.1%), while the transmittance of a camera lens array comprising lenses C is 0.990¹⁰=0.904 (90.4%). Thus, there is a difference as large as about 5.7% in transmittance between the camera lens array employing antireflection film A or B and the camera lens array employing antireflection film C. As can be understood therefrom, there arises a great difference in optical characteristics between the two camera arrays. This means that the antireflection films A and B have very good optical characteristics.

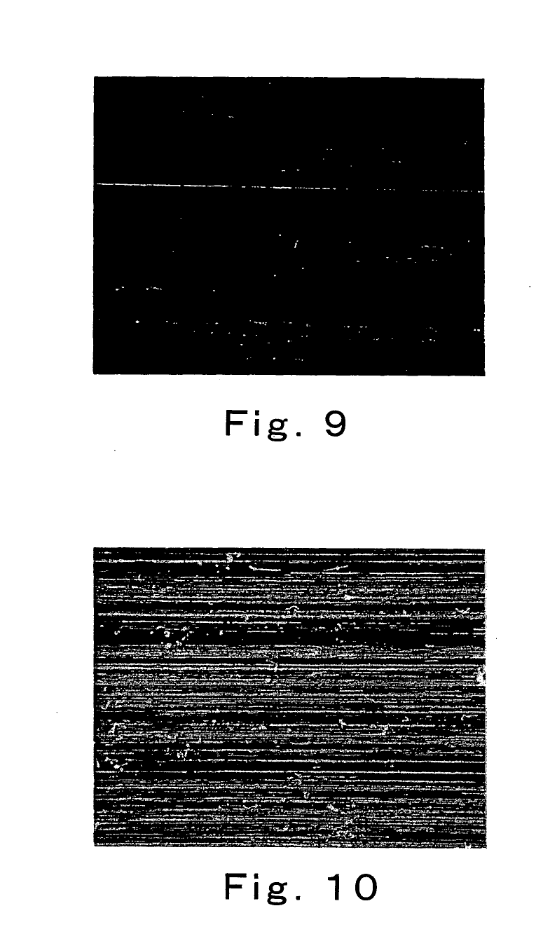

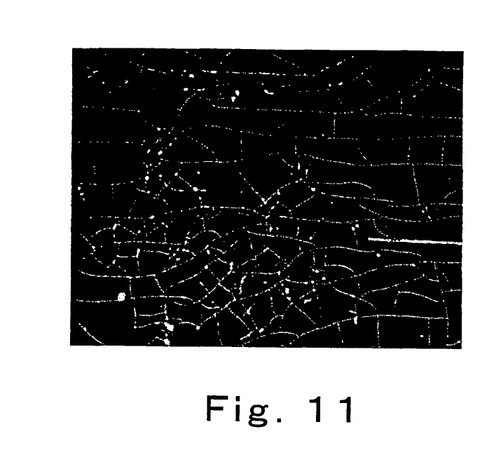

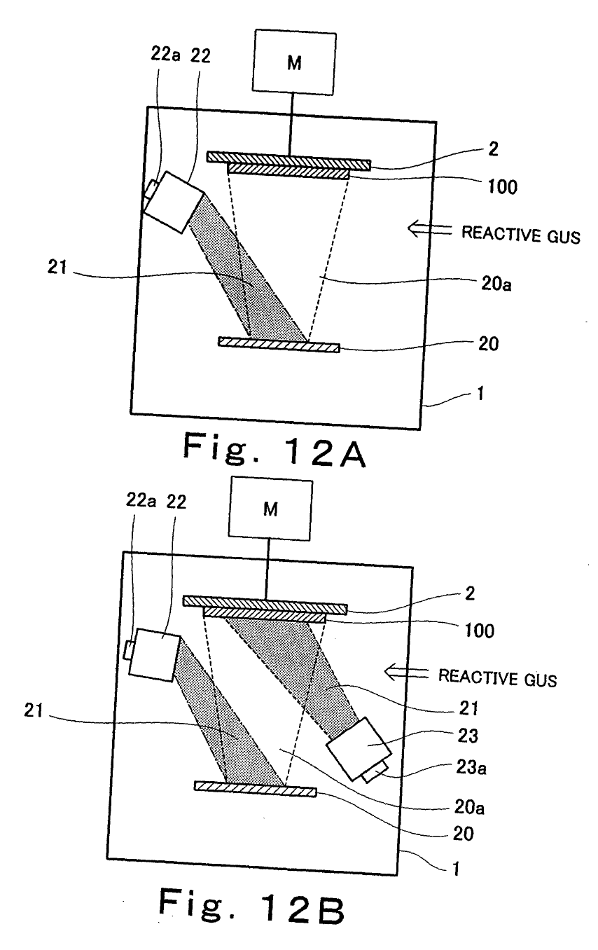

FIGS. 9 and 10 are photographs representing the result of a wear resistance test conducted on the antireflection films A and B and the result of a wear resistance test conducted on the antireflection film C., respectively. As can be seen from FIGS. 9 and 10, the antireflection films A and B exhibited no peeling and few flaws and hence have higher wear resistance than the antireflection film C.

As has been described in detail, the present invention is capable of realizing an optical antireflection film which is excellent in adhesion to an underlying substrate formed from a synthetic resin, environmental resistance, wear resistance and chemical resistance and which has a silicon oxide film having favorable optical characteristics, as well as of realizing a process for forming such an optical antireflection film.

Further, the present invention is capable of realizing an optical antireflection film having a superior antireflection characteristic which employs a substrate formed from a synthetic resin and which comprises a so-called HLHL type multi-layered film wherein a film forming the layer next to the outermost layer is imparted with a refractive index much higher than in the prior art.

Moreover, the present invention is capable of realizing an optical antireflection film having a superior antireflection characteristic which employs a substrate formed from a synthetic resin and which comprises a so-called MHL type multi-layered film including a MgF₂ film having sufficient hardness and a sufficiently low refractive index suited for an optical film.

While the antireflection film A according to this embodiment has the HLHL type multi-layered film consisting of four layers as shown in FIG. 1, such an HLHL type multi-layered film may consist of five or more layers.

The respective materials of the layers constituting each of the antireflection films A and B shown in FIGS. 1 and 3 are not limited to the materials mentioned above, and any other materials may be used to form the layers of each of the antireflection films A and B. As for the HLHL type antireflection film A shown in FIG. 1, for example, though the fifth layer 105 having a high refractive index situated next to the outermost layer comprises TiO₂ as a major component, the fifth layer 105 having such a characteristic may comprise a transparent material having a high refractive index ranging from 2.2 to 2.4 other than TiO₂. Specifically, the fifth layer 105 of the antireflection film A may comprise one selected from the group consisting of TiO₂, ZrO₂, Ti₂O₅, Ti₂O₃, Ti₃O₅, Ta₂O₅, Nb₂O₅, and a mixture of TiO₂ and ZrO₂, as a major component thereof. The sixth layer 106 as the outermost layer having a low refractive index of the antireflection film A shown in FIG. 1 may consist of a MgF₂ film formed by the above-described ion plating method. If the sixth layer 106 consists of such a MgF₂ film, the layer 106 can be imparted with sufficient hardness and a sufficiently low refractive index, thereby providing for a superior antireflection film.

The first and second layer formed on each of the substrates 100 and 200 may comprise any other silicon oxide than SiO or any other material. What is more, the first and second layers may comprise respective materials that are different from each other. Where the first and second layers are constructed of a same material, the adhesion therebetween is favorable. Further, where the first and second layers are constructed of SiO as in this embodiment, the advantages of the present invention in optical characteristics and the like can be obtained effectively.

While the TiO₂ film forming the fifth layer 105 of the HLHL type antireflection film A shown in FIG. 1 has been described to be formed by the above-described ion planting method (i.e., the special ion plating method utilizing plasma generated by application of high-frequency voltage) in this embodiment, it is possible to form such a TiO₂ film by an ion beam deposition method using an ion gun or a method using a plasma gun. Such methods will be described in detail below.

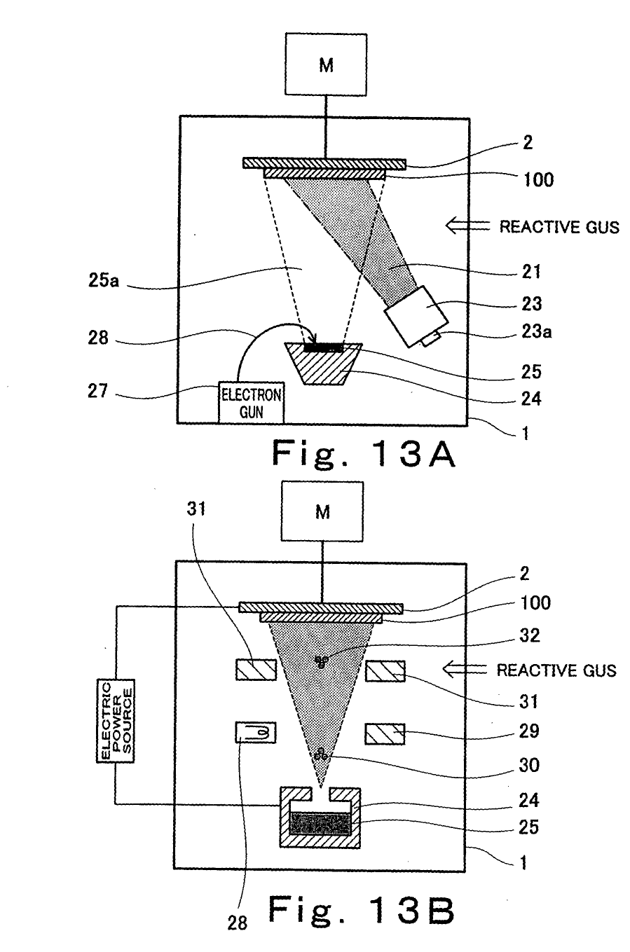

FIGS. 12A, 12B, 13A and 13B are each a schematic illustration of another example of film forming apparatus capable of forming optical films such as the TiO₂ film forming the fifth layer 105 of the antireflection film A shown in FIG. 1. In this embodiment each of the film forming apparatus shown is constructed to be capable of forming a film based on an ion beam deposition method instead of the foregoing ion plating method.

The film forming apparatus shown in FIG. 12A includes a vacuum chamber 1 within which a substrate holder 2 is disposed on an upper side for holding a substrate 100. The substrate holder 2 is driven for rotation by a motor M. A target 20 comprising a film forming material as a major component thereof is placed on a lower side within the vacuum chamber 1 so as to face opposite to the film-forming side of the substrate 100 attached to the substrate holder 2. Here, the target 20 comprises Ti as a major component thereof. On an inner lateral side of the vacuum chamber 1, an ion gun 22 for irradiating the major surface of the target 20 with an ion beam 21 from above is disposed. The ion gun 22 is provided with an ion source supply section 22a for supplying gas as an ion source to the ion gun 22. In the film forming apparatus shown, the ion source supply section 22a supplies argon gas to the ion gun 22, as will be described later. A conventional ion gun can be employed as the ion gun 22. Though not shown, the ion gun 22 includes therein a discharge electrode for generating plasma, a structure for forming an ion beam by selectively taking ions out of plasma generated, and the like.

Though not shown either, the film forming apparatus is provided with evacuation means such as a vacuum pump and a reactive gas supply means, as in the foregoing embodiment. Thus, the film forming apparatus is capable of providing the inside space of the vacuum chamber 1 with a desired vacuum atmosphere or with, for example, a desired reactive gas atmosphere (an oxygen atmosphere in this case).

The following description is directed to a process for forming a TiO₂ film as the fifth layer of the antireflection film A shown in FIG. 1.

First, as shown in FIG. 1, substrate 100 formed with the first to fourth layers 101 to 104 on the surface thereof is set on the substrate holder 2. Here, the side of the substrate 100 on which the first to fourth layers 101 to 104 have been formed is the film forming side on which the TiO₂ film is to be formed and, hence, the substrate 100 is set on the substrate holder 2 so that its film forming side is oriented inwardly of the chamber 1. On the other hand, the target 20 is placed on the lower side within the vacuum chamber 1 so as to face opposite to the film forming side of the substrate 100. Then, the vacuum chamber 1 is evacuated to provide a desired vacuum atmosphere therein, while oxygen gas as the reactive gas is supplied into the chamber 1 to provide a desired oxygen atmosphere in the chamber 1.

Subsequently, the ion source supply section 22a supplies argon gas to the ion gun 22, which in turn causes discharge to occur therein to generate plasma and selectively takes argon ions out of the plasma. The ion gun 22 then emits a flux of argon ions thus taken out (hereinafter referred to as “ion beam”) toward the target 20 to irradiate the target 20 with an ion beam 21. Such irradiation causes the film forming material (i.e., Ti) constituting the target 20 to be sputtered and evaporated by such ions. Ti 20a thus evaporated reacts with the oxygen gas within the chamber to produce TiO₂, which in turn adheres to and deposit on the substrate 100, thus forming a TiO₂ film. Such film formation is performed with the substrate 100 rotating together with the substrate holder 2.

Thus, the film forming apparatus having the ion gun 22 is also capable of forming a TiO₂ film having a high refractive index without heating the substrate 100 to a high temperature as with the foregoing ion plating method.

The film forming apparatus shown in FIG. 12B is similar in construction to the film forming apparatus shown in FIG. 12A, but is different therefrom in the following feature. That is, this example of film forming apparatus has an ion gun 23 disposed on a lower lateral side in the apparatus in addition to ion gun 22 which is disposed on an upper lateral side in the apparatus as in the apparatus shown in FIG. 12A. Here, the upper ion gun 22 is referred to as the first ion gun, while the lower ion gun 23 referred to as the second ion gun. The first and second ion guns 22 and 23 each have the same construction as in the conventional ion gun and are each supplied with argon gas as an ion source as in the apparatus shown in FIG. 12A.

In this apparatus having two such ion guns 22 and 23, the first ion gun 22 irradiates target 20 with ion beam 21 to evaporate Ti as a film forming material as does the ion gun of FIG. 12A. Ti 20a thus evaporated is utilized to form a TiO₂ film as in the case of FIG. 12A. The second ion gun 23, on the other hand, assists the first ion gun 22 in order to render the film denser. Specifically, the second ion gun 23 irradiates the TiO₂ film deposited on the film forming side of the substrate 100 with ion beam 21 from the lower side of the apparatus to compact the TiO₂ film (this process is referred to as “bombardment”). This example of film forming apparatus is capable of compacting a deposited TiO₂ film by means of the second ion gun 23 and hence is capable of forming a denser TiO₂ film, which is an advantage in addition to the aforementioned advantages in relation to FIG. 12A.

The film forming apparatus shown in FIG. 13A is similar in construction to the film forming apparatus shown in FIG. 12B, but is different therefrom in the following feature. That is, this example of film forming apparatus is constructed to irradiate a film forming material 25 filling a crucible 24 with an electron beam 28 emitted from an electron gun 27 to evaporate the material 25, instead of sputtering the target 20 by means of the first ion gun 22 to evaporate the film forming material (Ti). Specifically, the apparatus includes the crucible 24 disposed so as to face opposite to substrate 100 held by substrate holder 2, the electron gun 27 for emitting electron beam 28 toward the film forming material (Ti) filling the crucible 24, and an electron beam guiding structure (not shown) for deflecting electron beam 28 to guide it to the film forming material 25.

The electron gun 27 is of a conventional construction. That is, the electron gun 27 includes a filament therewithin, which generates thermal electrons when heated, though not illustrated herein. A flux of such thermal electrons (hereinafter referred to as “electron beam”) 28 is emitted from the electron gun 27. Then, the electron beam 28 is guided to the crucible 24 by the electron beam guiding structure employing a magnet for example to irradiate the film forming material 25 with the electron beam 28, thereby evaporating the film forming material 25. The evaporated film forming material 25a reacts with oxygen gas within the chamber to produce TiO₂, which in turn adheres to and deposit on the film forming side of the substrate 100. As in the case of FIG. 12B, this film forming apparatus causes ion gun 23 to assist in the film formation by irradiating the TiO₂ film thus deposited with ion beam 21 to render the film denser as described above.

The film forming apparatus shown in FIG. 13B includes a vacuum chamber 1, a substrate holder 2 disposed in the vacuum chamber 1, the substrate holder 2 being constructed of an electro-conductive material, and a crucible 24 disposed so as to face opposite to the film forming side of a substrate 100 held by the substrate holder 2, the crucible 24 being filled with a film forming material (Ti) 25. The crucible 24, which is formed from an electro-conductive material, and the substrate holder 2 are serially connected to an electric power source. In the space between the crucible 24 and the substrate holder 2 within the chamber 1 are disposed a filament 28 capable of being heated and an ionization electrode 29 so as to be opposed to each other in a direction intersecting an imaginary line that links the crucible 24 and the substrate 100. Further, a pair of accelerating electrodes 31, which are opposed to each other in the aforementioned intersecting direction, are located closer to the substrate holder 2 than the pair of filament 28 and ionization electrode 29. The accelerating electrodes 31 are connected to an electric power source not shown.

Though not shown, this example of film forming apparatus is provided with evacuation means for evacuating the vacuum chamber 1 and reactive gas supply means for supplying a reactive gas into the chamber 1. In this case oxygen is used as the reactive gas.

In this apparatus a voltage is applied across the substrate holder 2 and the crucible 24 to evaporate the film forming material (Ti) 25 billowingly from the crucible 24 to form a neutral cluster 30 of the material 25. The “cluster”, as used herein, means a state where 500 to 1000 atoms are loosely bound with each other. In turn, the filament 28 is heated to generate thermal electrons, by causing discharge to occur between the thermal electrons and the ionization electrode 29 the cluster 30 is ionized. Hereinafter, the cluster thus ionized will be referred to as ionized cluster 32. The ionized cluster 32 reacts with oxygen gas within the chamber 1 and the reaction product is accelerated to travel toward the substrate 100 by the accelerating electrodes 31 and adheres to and deposits on the film forming side of the substrate 100. Thus, a TiO₂ film is formed. This example of film forming apparatus, which is adapted to turn the film forming material itself into an ion beam in the manner described above, can also enjoy advantages similar to those obtained by the aforementioned apparatus employing an ion gun. In addition, this apparatus causes the film forming material to form an ionized cluster and hence is capable of obtaining a film of better film quality.

It should be noted that each of the film forming apparatus shown in FIGS. 12A, 12B and 13B is not designed to apply a bias voltage onto the substrate side during film formation and hence is incapable of applying a positive bias and a negative bias to the substrate side as in the case of the foregoing ion plating. For this reason, if these apparatus are applied to the formation of the MgF₂ film of antireflection film B shown in FIG. 3, the apparatus cannot obtain the advantage of the foregoing ion plating method that application of an appropriate positive bias to the substrate side can prevent dissociation of fluorine. On the other hand, since the film forming apparatus shown in FIG. 13B is configured to apply a voltage to the substrate side, the apparatus is capable of applying an appropriate positive bias to the substrate side. Accordingly, use of the apparatus for forming the MgF₂ film of antireflection film B shown in FIG. 3 makes it possible to obtain the fluorine dissociation preventive effect as with the foregoing ion plating method.

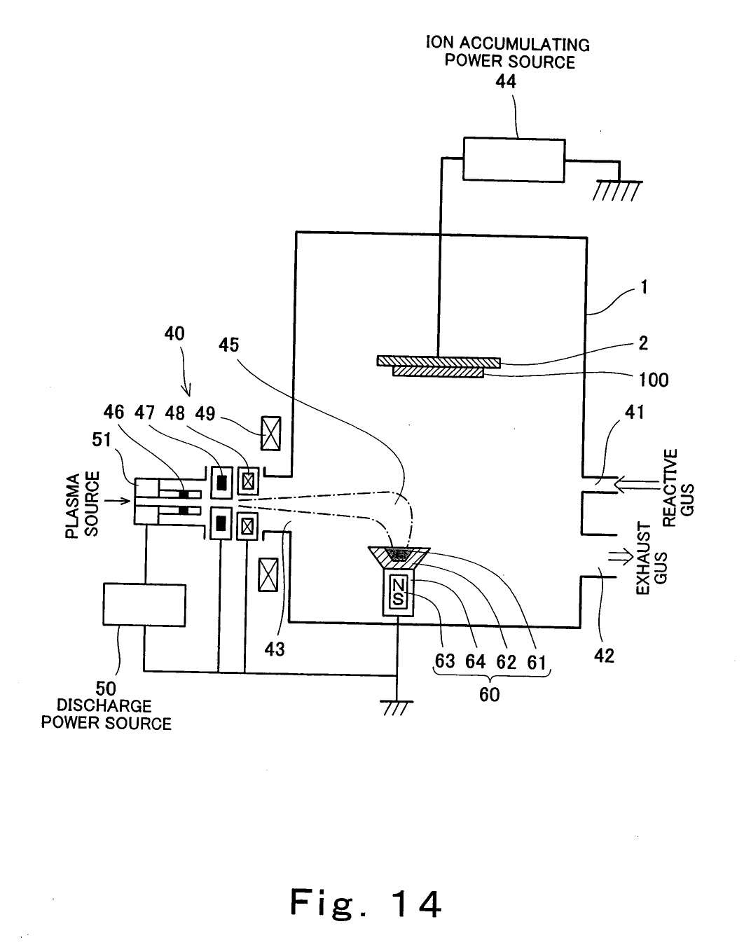

FIG. 14 is a schematic illustration of still another example of film forming apparatus capable of forming optical films such as the TiO₂ film forming the fifth layer 105 of antireflection film A shown in FIG. 1, and the MgF₂ film forming the fifth layer 205 of antireflection film B shown in FIG. 3. In this embodiment the film forming apparatus is constructed to be capable of forming a film based on a method employing a plasma gun instead of the ion gun used in each of the embodiments shown in FIGS. 12 and 13.

As shown in FIG. 14, this example of film forming apparatus includes a vacuum chamber 1, and a plasma gun 40 for generating plasma within the vacuum chamber 1. Though not shown, this film forming apparatus is provided with evacuation means, such as a vacuum pump, for evacuating the vacuum chamber 1 and reactive gas supply means, such as a feed pump, for supplying a reactive gas into the chamber 1. In this case oxygen is supplied as the reactive gas.

The vacuum chamber 1 has a reactive gas supply port 41, an exhaust vent 42, and a plasma introducing port 43. The reactive gas supply port 41 is connected to the reactive gas supply means not shown, the exhaust vent 42 connected to the evacuation means (not shown), and the plasma introducing port 43 connected to the plasma gun 40. On an upper side within the vacuum chamber 1 is disposed a substrate holder 2 for holding a substrate 100. The substrate holder 2, which is constructed of an electro-conductive material, is electrically connected to an ion accumulating power source 44 located outside the chamber 1. The ion accumulating power source 44 is grounded. The substrate holder 2 is driven for rotation by a motor (not shown).

An evaporation source 60 is disposed on a lower side within the vacuum chamber 1. The evaporation source 60 comprises a crucible 62 to be filled with a film forming material 61, and a support member 64 within which is located an electron beam accumulating magnet 63 for deflecting the advancing direction of an electron beam 45 emitted from the plasma gun 40 to irradiate the film forming material 61 with the electron beam 45 as will be described later. The evaporation source 60, which is constructed of an electro-conductive material, is connected to a discharge power source 50 and grounded. The evaporation source 60 thus arranged functions as an anode during discharge for the generation of plasma to be described later.

The plasma gun 40 flanks the vacuum chamber 1 and defines an inside space communicating with the inside of the vacuum chamber 1 for permitting electron beam 45 generated within the gun 40 to be introduced into the vacuum chamber 1 through the electron beam introducing port 43. The plasma gun 40 used in this apparatus is a conventional plasma gun.

Specifically, a pair of opposite plasma generating cathodes 46 are disposed within the plasma gun 40, and first and second intermediate electrodes 47 and 48 are located in that order in the electron beam advancing path between a connecting portion of the plasma gun 40 to the vacuum chamber 1 and the cathodes 46. Further, the plasma gun 40 is provided with a pair of coils 49 disposed adjacent the connecting portion for converging a flux of plasma. The electrodes 46, 47 and 48 are connected to the discharge power source 50, to which the evaporation source 60 is connected, through wiring provided with an appropriate resistor. The plasma gun 40 has a carrier gas inlet 51 defined upstream of each cathode 46 and connected to carrier gas supply means (not shown). In this film forming apparatus the carrier gas supply means supplies the plasma gun 40 with argon gas as a plasma source.

The following description is directed to a process for forming a TiO₂ film as the fifth layer 105 of antireflection film A of FIG. 1 with use of the apparatus thus constructed.

First, as shown in FIG. 1, substrate 100 formed with first to fourth layers 101 to 104 on the surface thereof is set on the substrate holder 2. In this case the side of the substrate 100 on which the layers 101 to 104 have been formed is the film forming side to be formed with the TiO₂ film. The substrate is positioned so that its film forming side is oriented inwardly of the chamber 1. Then, the crucible 62 is filled with the film forming material 61. Though Ti is used as the film forming material 61 in this case, any titanium oxide such as TiO₂ may be used as the film forming material. Subsequently, the evacuation means (not shown) evacuates the vacuum chamber 1 through the exhaust vent 4 to turn the atmosphere inside the chamber 1 into a predetermined vacuum condition, while the reactive gas supply means (not shown) supplies a predetermined amount of oxygen gas serving as the reactive gas into the chamber 1 through the reactive gas supply port 41.

On the other hand, the carrier gas supply means (not shown) supplies argon gas as the carrier gas for generating plasma into the plasma gun 40 through the carrier gas inlet 51. Argon gas thus supplied is turned into a plasmatic state due to discharge between the cathodes 46 and the evaporation source 60 serving as the anode. Then, electrons are selectively taken out of plasma by the respective actions of the first and second intermediate electrodes 47 and 48. A flux of electrons (i.e., electron beam 45) thus taken out of plasma is converged by the plasma flux converging coils 49. Further, the flux thus converged is subjected to the action of a magnetic field produced by the electron beam accumulating magnet 63 of the evaporation source 60. Thus, the electron beam 45 is introduced into the vacuum chamber 1 through the plasma introducing port 43, so that the film forming material 61 in the crucible 62 is irradiated with the electron beam 45. The film forming material 61 thus irradiated with the electron beam 45 is evaporated. Further, electrons of the electron beam 45 collide with the oxygen gas within the chamber 1, thereby generating plasma within the chamber 1.

The film forming material 61 thus evaporated is excited, hence, ionized by the plasma generated within the chamber 1 during the passage thereof through the plasma. Since this example of film forming apparatus, in particular, is capable of ionizing a high concentration portion of vapor evaporated from the film forming material 61 irradiated with the electron beam 45 by the plasma, this apparatus offers improved ionization efficiency.

The film forming material thus ionized reacts with oxygen within the chamber 1 and the reaction product is accelerated to travel toward the substrate 100 by a bias voltage that is applied to the substrate side by the ion accumulating power source 44. Finally, the reaction product impinges and deposits on the film forming side of the substrate 100, thus forming the TiO₂ film on the film forming side of the substrate 100.

This embodiment employs the plasma gun 40 and hence is capable of forming a denser film. Further, this embodiment ensures improved ionization efficiency and hence can enhance the reactivity of the film forming material and improve the film quality.

The above description is directed to the case where the TiO₂ film is formed using the film forming apparatus having the plasma gun according to this embodiment. However, the apparatus may be used to form the MgF₂ film as the fifth layer 205 of antireflection film B shown in FIG. 3. In this case the aforementioned fluorine dissociation preventive effect can be obtained when an appropriate bias as shown in FIG. 6 is applied to the substrate side by the ion accumulating power source 44.

As has been described above, the present invention is capable of providing an optical antireflection film which is satisfactory in adhesion to an underlying substrate formed from a synthetic resin, environmental resistance, wear resistance and chemical resistance and which has advantageous optical characteristics, as well as of providing a process for forming the same.

Further, the present invention is capable of providing an optical antireflection film which employs a substrate formed from a synthetic resin and which comprises a so-called HLHL type multi-layered film in which a film forming the layer next to the outermost layer has a refractive index much higher than in the prior art, as well as of providing a process for forming the same.

Moreover, the present invention is capable of providing an optical antireflection film which employs a substrate formed from a synthetic resin and which comprises a so-called MHL type multi-layered film including a MgF₂ film having sufficient hardness and a sufficiently low refractive index suited for an optical film, as well as of providing a process for forming the same.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An optical antireflection film formed on a substrate formed from a synthetic resin, comprising: a first film formed on a surface of the substrate, the first film having a predetermined thickness and a refractive index substantially equal to a refractive index of the substrate; a second film formed on a surface of the first film, the second film having a predetermined thickness and a refractive index assuming a value falling within a range from 1.48 to 1.62 and comprising a material same as or different from a material forming the first film; and a multi-layered film formed on a surface of the second film, the multi-layered film having an antireflection characteristic.

2. The optical antireflection film in accordance with claim 1, wherein the first and second films each comprise a silicon oxide.

3. The optical antireflection film in accordance with claim 1, wherein the substrate is formed from an acrylic resin.

4. The optical antireflection film in accordance with claim 1, wherein the first film is a product obtained by a vacuum deposition method utilizing resistance heating.

5. The optical antireflection film in accordance with claim 1, wherein the multi-layered film comprises films stacked in a manner that adjacent ones of the films have respective refractive indexes that are different from each other while the films have respective refractive indexes that alternately and relatively assume high/low values.

6. The optical antireflection film in accordance with claim 5, wherein the multi-layered film has a third film as a layer next to an outermost layer which is situated most remotely from the second film, the third film having a refractive index assuming a value falling within a range from 2.2 to 2.4.

7. The optical antireflection film in accordance with claim 6, wherein the third film comprises one selected from the group consisting of TiO₂, Ti₂O₃, Ti₃O₅, Ta₂O₅, ZrO₂, Nb₂O₅, and a mixture of TiO₂ and ZrO₂, as a major component thereof.

8. The optical antireflection film in accordance with claim 6, wherein the third film is obtainable by a process in which a film forming apparatus comprising a vacuum chamber and a bias supply electrode disposed within the vacuum chamber is employed and which comprises the steps of: placing the substrate on the bias supply electrode; evaporating a film forming material within the vacuum chamber; supplying a high-frequency voltage to the bias supply electrode serving as one electrode to generate plasma within the vacuum chamber; and applying the bias supply electrode with a bias voltage having a frequency of not less than 20 KHz and not more than 2.45 GHz and varying in a wave form.

9. The optical antireflection film in accordance with claim 8, wherein the bias voltage has a negative mean value and a positive maximum value.

10. The optical antireflection film in accordance with claim 6, wherein the third film is obtainable by a process in which a film forming apparatus comprising a vacuum chamber and an ion beam generating structure for generating an ion beam for use in film formation is employed and which comprises the steps of: placing the substrate within the vacuum chamber; causing the ion beam generating structure to generate the ion beam; and depositing a film forming material on a surface of the substrate by utilizing the ion beam within the vacuum chamber.

11. The optical antireflection film in accordance with claim 10, wherein the ion beam generating structure is an ion gun, while the step of depositing the film forming material comprises the steps of: irradiating the film forming material with the ion beam generated by the ion gun to evaporate the film forming material; and depositing the film forming material thus evaporated on the surface of the substrate.

12. The optical antireflection film in accordance with claim 6, wherein the third film is obtainable by a process in which a film forming apparatus comprising a vacuum chamber, a plasma generating structure for generating plasma to be supplied into the vacuum chamber, and a bias supply electrode disposed within the vacuum chamber is employed and which comprises the steps of: placing the substrate on the bias supply electrode; causing the plasma generating structure to generate plasma thereby to generate an electron beam comprising electrons present in the plasma and guiding the electron beam into the vacuum chamber; irradiating a film forming material with the electron beam to evaporate the film forming material; generating plasma within the vacuum chamber by the electron beam; and applying the bias supply electrode with a bias voltage to cause the film forming material evaporated to deposit on a surface of the substrate.

13. The optical antireflection film in accordance with claim 12, wherein the plasma generating structure is a plasma gun.

14. The optical antireflection film in accordance with claim 1, wherein the multi-layered film comprises stacked three layers comprising an outer layer film situated most remotely from the second film, an inner layer film situated most closely to the second film, and an intermediate layer film situated intermediate between the outer layer film and the inner layer film,
the outer layer film having a refractive index that is lowest of refractive indexes of the respective films forming the three layers, the intermediate layer film having a refractive index that is highest of the refractive indexes of the respective films forming the three layers, the inner layer film having a refractive index that assumes a medium value between the refractive index of the outer layer film and that of the intermediate layer film.

15. The optical antireflection film in accordance with claim 14, wherein the outer layer film comprises magnesium fluoride (MgF₂) as a major component thereof.

16. The optical antireflection film in accordance with claim 14, wherein the outer layer film is obtainable by a process in which a film forming apparatus comprising a vacuum chamber and a bias supply electrode disposed within the vacuum chamber is employed and which comprises the steps of: placing the substrate on the bias supply electrode; evaporating a film forming material within the vacuum chamber; supplying a high-frequency voltage to the bias supply electrode serving as one electrode to generate plasma within the vacuum chamber; and applying the bias supply electrode with a bias voltage having a negative mean value and a positive maximum value and a frequency of not less than 20 KHz and not more than 2.45 GHz and varying in a wave form.

17. The optical antireflection film in accordance with claim 14, wherein the outer layer film is obtainable by a process in which a film forming apparatus comprising a vacuum chamber, a plasma generating structure for generating plasma to be supplied into the vacuum chamber, and a bias supply electrode disposed within the vacuum chamber is employed and which comprises the steps of: placing the substrate on the bias supply electrode; causing the plasma generating structure to generate plasma thereby to generate an electron beam comprising electrons present in the plasma and guiding the electron beam into the vacuum chamber; irradiating a film forming material with the electron beam to evaporate the film forming material; generating plasma within the vacuum chamber by the electron beam; and applying the bias supply electrode with a bias voltage having a negative mean value and a positive maximum value to cause the film forming material evaporated to deposit on a surface of the substrate.

18. A process for forming an optical antireflection film on a substrate formed from a synthetic resin, comprising the steps of:
forming a first film to a predetermined thickness on a surface of the substrate by a vacuum deposition method utilizing resistance heating, the first film having a refractive index substantially equal to a refractive index of the substrate;
forming a second film to a predetermined thickness on a surface of the first film by a vacuum deposition method utilizing resistance heating, the second film having a refractive index assuming a value falling within a range from 1.48 to 1.62 and comprising a material same as or different from a material forming the first film; and
forming a multi-layered film having an antireflection characteristic on a surface of the second film.

19. The process in accordance with claim 18, wherein the first and second films each comprise a silicon oxide as a major component thereof.

20. The process in accordance with claim 18, wherein the step of forming the multi-layered film comprises the step of stacking films on the surface of the second film in a manner that adjacent ones of the films have respective refractive indexes that are different from each other and alternately and relatively assume high/low values,
the step of stacking the films comprising the step of forming a third film as a layer next to an outermost layer which is situated most remotely from the substrate, the third film comprising one film forming material selected from the group consisting of TiO₂, Ti₂O₃, Ti₃O₅, Ta₂O₅, ZrO₂, Nb₂O₅, and a mixture of TiO₂ and ZrO₂, as a major component thereof.

21. The process in accordance with claim 20, wherein in the step of forming the third film, a film forming apparatus comprising a vacuum chamber and a bias supply electrode disposed within the vacuum chamber is employed, and the step of forming the third film comprises the steps of: placing the substrate on the bias supply electrode; evaporating one film forming material selected from said group within the vacuum chamber; supplying a high-frequency voltage to the bias supply electrode serving as one electrode to generate plasma within the vacuum chamber; and applying the bias supply electrode with a bias voltage having a frequency of not less than 20 KHz and not more than 2.45 GHz and varying in a wave form.

22. The process in accordance with claim 21, wherein in the step of applying the bias supply electrode with a bias voltage, the bias voltage has a negative mean value and a positive maximum value.

23. The process in accordance with claim 20, wherein in the step of forming the third film, a film forming apparatus comprising a vacuum chamber and an ion gun for generating an ion beam to irradiate a film forming material placed within the vacuum chamber with the ion beam is employed, and the step of forming the third film comprises the steps of: placing the substrate within the vacuum chamber; generating the ion beam by the ion gun and irradiating one film forming material selected from said group with the ion beam thus generated to evaporate the film forming material; and depositing the film forming material thus evaporated on a surface of the substrate.

24. The process in accordance with claim 20, wherein in the step of forming the third film, a film forming apparatus comprising a vacuum chamber, a plasma gun for generating plasma to be supplied into the vacuum chamber, and a bias supply electrode disposed within the vacuum chamber is employed, and the step of forming the third film comprises the steps of: placing the substrate on the bias supply electrode; causing the plasma gun to generate plasma thereby to generate an electron beam comprising electrons present in the plasma and guiding the electron beam into the vacuum chamber; irradiating one film forming material selected from said group with the electron beam thus generated to evaporate the film forming material; generating plasma within the vacuum chamber by the electron beam; and applying the bias supply electrode with a bias voltage to cause the film forming material evaporated to deposit on a surface of the substrate.

25. The process in accordance with claim 18, wherein the step of forming the multi-layered film comprises the steps of: forming an inner layer film situated most closely to the second film; forming an intermediate layer film on the inner layer film; and forming an outer layer film situated most remotely from the second film, the outer layer film having a refractive index that is lowest of refractive indexes of the respective films forming the three layers, the intermediate layer film having a refractive index that is highest of the refractive indexes of the respective films forming the three layers, the inner layer film having a refractive index assuming a medium value between the refractive index of the outer layer film and that of the intermediate layer film, the step of forming the outer layer film is the step of forming a film comprising magnesium fluoride as a major component thereof.

26. The process in accordance with claim 25, wherein the step of forming the outer layer film comprising magnesium fluoride as a major component thereof employs a film forming apparatus comprising a vacuum chamber and a bias supply electrode disposed within the vacuum chamber, and comprises the steps of: placing the substrate on the bias supply electrode; evaporating magnesium fluoride as a film forming material within the vacuum chamber; supplying a high-frequency voltage to the bias supply electrode serving as one electrode to generate plasma within the vacuum chamber; and applying the bias supply electrode with a bias voltage having a negative mean value and a positive maximum value and a frequency of not less than 20 KHz and not more than 2.45 GHz and varying in a wave form.

27. The process in accordance with claim 25, wherein the step of forming the outer layer film comprising magnesium fluoride as a major component thereof employs a film forming apparatus comprising a vacuum chamber, a plasma gun for generating plasma to be supplied into the vacuum chamber, and a bias supply electrode disposed within the vacuum chamber, and comprises the steps of: placing the substrate on the bias supply electrode; causing the plasma gun to generate plasma thereby to generate an electron beam comprising electrons present in the plasma and guiding the electron beam into the vacuum chamber; irradiating magnesium fluoride as a film forming material with the electron beam to evaporate the magnesium fluoride within the vacuum chamber; generating plasma within the vacuum chamber by the electron beam; and applying the bias supply electrode with a bias voltage having a negative mean value and a positive maximum value to cause the film forming material evaporated to deposit on a surface of the substrate.
